(19) United States
(12) Patent Application Publication
(10) Pub. No.: US 2020/0044748 A1
(43) Pub. Date: Feb. 6, 2020

(54) A Receiver Assembly Comprising a Radiation Guide

(71) Applicant: OXFORD UNIVERSITY INNOVATION LIMITED, Oxford (GB)

(72) Inventors: Dominic Christopher O'Brien, Oxford (GB); Stephen Collins, Oxford (GB); Andrew Archibald Ronald Watt, Oxford (GB); Grahame Edward Faulkner, Oxford (GB); Inji Yeom, Oxford (GB)

(73) Assignee: OXFORD UNIVERSITY INNOVATION LIMITED, Oxford (GB)

(21) Appl. No.: 16/319,662

(22) PCT Filed: Jul. 17, 2017
(86) PCT No.: PCT/GB2017/052095

§ 371 Date: Jan. 22, 2019

(30) Foreign Application Priority Data
Jul. 22, 2016 (GB) 1612737.5

(51) Int. Cl. H04B 10/67; G02B 6/42; H04B 10/25

(52) U.S. Cl. CPC H04B 10/675; H04B 10/25; G02B 6/4206; G02B 6/4215

(57) ABSTRACT

A receiver assembly (1) has a radiation guide (4) having an elongate form. The length is at least five times longer than all dimensions of the radiation guide perpendicular to the longitudinal axis (3). The guide receives radiation via an outer lateral surface (8), converts the radiation to longer wavelength radiation, and guides the converted radiation to a longitudinal end surface (2). A receiver unit (5) receives radiation output from the longitudinal end surface.

The invention relates to optical data communications using optical concentrators.

Market research published in 2014 predicted that by 2019 there will be 11.5 billion mobile-connected devices in the world and that these devices will contribute to a tenfold increase in global mobile data traffic between 2014 and 2019. It is anticipated that high concentrations of devices using the RF spectrum will generate so much interference that service quality will be significantly degraded. A key part of the solution to this expected spectrum crunch is to exploit new parts of the electromagnetic spectrum to support mobile wireless communications.

A part of the electromagnetic spectrum not currently used widely for wireless communications is visible light. The possibility of exploiting this part of the spectrum economically is increasing, due to the growing use of light emitting diodes (LEDs) for lighting. Unlike some other lighting technologies, LEDs can be modulated at relatively high frequencies. For example, micro-LEDs can be modulated at frequencies up to 185 MHz. These frequencies are suitable for wireless communications using existing infrastructure. Other potential advantages of visible light communication (VLC) include the lack of electromagnetic interference, the ability to localise light within a space to support many users and the improved cyber-security arising from the fact that light does not penetrate walls.

For indoor VLC lighting LEDs can be used as transmitters with a high signal to noise ratio. Receivers will each need to incorporate a photodetector which converts the modulated light into a modulated electrical signal. To have a large enough bandwidth the photodetectors will typically have to be fairly small (possibly of the order of 100-300 μm diameter). The signal falling on such small photodetectors may be increased using an optical concentrator such as a lens or a compound parabolic concentrator. However, the area of typical concentrators is limited by the conservation of étendue (constant radiance theorem), which means that the maximum gain, Gₘₐₓ, for a concentrator with a field of view θ is given by

$${G}_{max} = \frac{{n}^{2}}{{sin}^{2} θ} ,$$

where n is the refractive index of the concentrator.

The relationship between the étendue limited maximum theoretical optical gain and the half angle of the field of view of a concentrator is well-known. However, with gains of 1,000 or more the concentrator's aperture will have a diameter of less than 1 cm. Such small apertures will be vulnerable to being accidentally blocked. Furthermore, the high gain reduces the field of view (FOV). A gain of around 1,000 will be associated with a FOV of about 3°. This is likely to cause problems in many practical applications. For example, if VLC were to be used with handheld mobile terminals such as mobile phones or tablets, these would need to have concentrators with relatively large fields of view, for example around 20° or higher. Such fields of view would reduce the maximum theoretical gain of the concentrator to below 20. Unfortunately, a concentrator with a field of view of 20° or more will also have an aperture of 1 mm or less, and will therefore be vulnerable to blocking.

Changing the wavelength of radiation during the concentration process, using fluorescence for example, allows gains and/or fields of view to be achieved which are not constrained by conservation of étendue, and which can therefore be more favourable. Examples of arrangements based on this principle are disclosed for example in GB 2506383A and in ‘High gain, wide field of view concentrator for optical communications’, Steve Collins, Dominic C. O'Brien and Andrew Watt, OPTICS LETTERS, Vol. 39, No. 7, pp1756-1759 Apr. 1, 2014.

Optical concentration refers to the process of receiving light using a relatively large collecting aperture and concentrating that light onto a much smaller area, such that the photon flux density on the smaller area is larger than the photon flux density on the larger area. There are many applications for concentrators, including in free space optical communications and power generation. In the case of optical communications, light carries an information signal, and an optical receiver uses a concentrator to collect light from the largest area possible and concentrate it on a photo-detector.

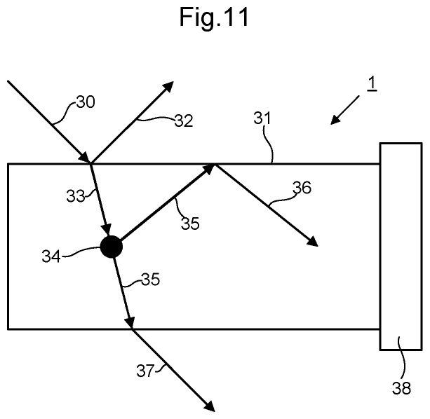

The principle of operation of a concentrator 1 comprising a wavelength converting element based on fluorescence is illustrated schematically in FIG. 11. Light 30 from a transmitter is incident on the front surface 31 of the concentrator 1, which acts as a collecting area of the concentrator 1. Some of this incident light will be reflected from the surface 31 (arrow 32) but most of the light will be transmitted into the concentrator 1 (arrow 33). Some of transmitted incident light will be absorbed by fluorophores 34 within the concentrator 1. Any fluorophore that has been excited by a photon of incident light might emit a photon with a longer wavelength in a random direction (arrows 35). Some of this emitted light will escape from the concentrator 1 (arrow 37) but most of it will be retained within the concentrator 1 by total internal reflection (arrow 36). If re-absorption by the fluorophore at the new wavelength is negligible this light will reach a detector 38 at an edge of the concentrator 1. Even if the retained light is absorbed by the fluorophore before it reaches the detector 38 it can still be emitted at an even longer wavelength, be retained by total internal reflection and reach the detector 38.

However the manufacturing process to produce conventional optical concentrators is typically complex, which increases the cost of such devices. This restricts the extent to which optical concentrators are cost-effective.

A further problem is that the data rates achievable by conventional optical concentrators may not be sufficient for high data rate communications applications in systems having a small volume and/or convenient shape.

It is an object of the invention to improve data communications based on optical concentration.

According to an aspect of the invention, there is provided a receiver assembly, comprising: a radiation guide having an elongate form with a length that is at least five times longer than all dimensions of the radiation guide perpendicular to the longitudinal axis, the radiation guide being configured to receive radiation via an outer lateral surface of the radiation guide, convert the received radiation to longer wavelength radiation within the radiation guide, and guide the converted radiation to a longitudinal end surface of the radiation guide; and a receiver unit configured to receive radiation output from the longitudinal end surface of the radiation guide.

Thus, an arrangement is provided in which radiation incident on an elongate surface can be concentrated onto a point-like surface, and in which wavelength conversion allows more favourable gains and/or fields of view than are possible using concentrators which are limited by conservation of étendue. Concentrating from an elongate surface to a point-like surface provides a unique geometry in concentrators of this type and extends the range of situations in which the receiver assembly can be used. The assembly can be used for example in conjunction with a concentrator which outputs radiation having an elongate geometry to achieve higher levels of overall concentration. The assembly facilitates use of small detectors, which can operate efficiently at high speed and increase bandwidth of communication devices using the assembly. Furthermore, the inventors have recognised that radiation guides having the required geometry are widely available (e.g. optical fibres) and can be cost effectively adapted to achieve the functions of the invention.

In an embodiment, wavelength converting elements are distributed non-uniformly through a cross-section of the radiation guide. Varying the concentration of the wavelength converting elements provides flexibility to achieve an optimal balance between efficiently converting radiation to longer wavelength radiation (favoured by regions of relatively high wavelength converting element density) and providing a low absorption path for the converted radiation to travel to the receiver (favoured by having paths of relatively low wavelength converting element density). The wavelength converting elements may be concentrated for example in regions where it is expected that incident radiation will be focussed by the particular geometry of the radiation guide. For example, in the case of a cylindrical radiation guide and plane wave incident radiation, it would be expected that radiation would be focussed towards a rear side of the radiation guide (the side opposite to the incident radiation) and wavelength converting elements would desirably then be localised towards the rear side. In such embodiments, more than 51% of the wavelength converting elements may desirably be located within an azimuthal angle of 180 degrees relative to the longitudinal axis, averaged over the length of the radiation guide. Alternatively or additionally, where the cross-section of the guide is mirror symmetric about a line of symmetry passing through the longitudinal axis, more than 51% of the wavelength converting elements are located to one side of the line of symmetry, averaged over the length of the radiation guide.

In an embodiment, a spatial density of wavelength converting elements in the radiation guide, averaged over the length of the radiation guide, varies as a function of radius relative to the longitudinal axis. This arrangement may be particularly easy to manufacture. In an embodiment, the radiation guide comprises a core of an optical fibre. High quality optical fibres are widely available and can be adapted in a cost-effective manner. For example, in an embodiment the radiation guide further comprises an outer layer on the core of the optical fibre and wherein the conversion of the received radiation to longer wavelength radiation is performed at least partially in the outer layer. The outer layer can be provided simply by replacing the outer cladding of a conventional optical fibre with the outer layer.

In an embodiment, the concentrator further comprises a concentration stage configured to concentrate radiation received via an input surface of the concentration stage onto the outer lateral surface of the radiation guide, wherein the input surface of the concentration stage is less elongate than the outer lateral surface of the radiation guide. In an embodiment the concentration stage comprises a plurality of the radiation guides. This arrangement provides lower edge losses than alternative arrangements. In an example embodiment, the concentration stage comprises a lens having an elongate focus. In an example embodiment, the lens is a Fresnel lens. Thus, arrangements may be provided in which concentration is achieved is several stages, with the elongate radiation guide providing a late or final stage of concentration. High overall concentration factors are achievable in this manner, facilitating high efficiency and/or high bandwidth communications.

According to an alternative aspect, there is provided a method of receiving radiation for data communications, comprising: receiving radiation on an outer lateral surface of a radiation guide having an elongate form with a length that is at least five times longer than all linear dimensions of the radiation guide perpendicular to the longitudinal axis; converting the received radiation to longer wavelength radiation within the radiation guide and guiding the converted radiation to a longitudinal end surface of the radiation guide; and receiving radiation output from the longitudinal end surface of the radiation guide.

Embodiments of the invention will now be described, by way of example only, with reference to the accompanying drawings in which corresponding reference symbols represent corresponding parts, and in which:

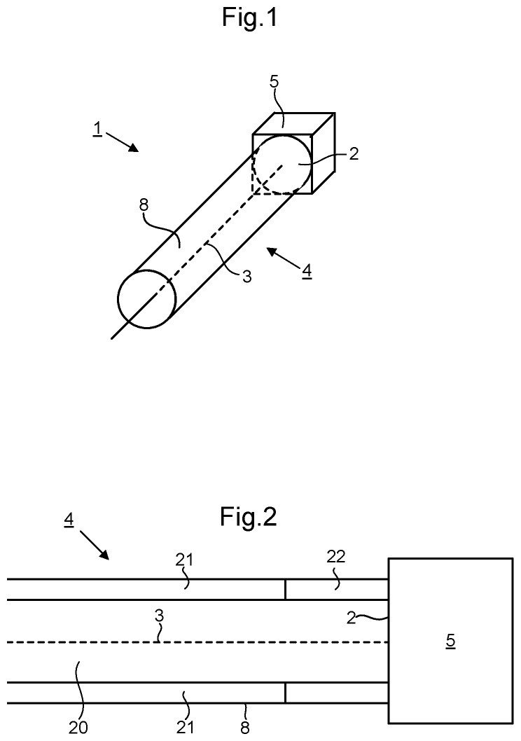

FIG. 1 is a schematic perspective view of a receiver assembly according to an embodiment;

FIG. 2 is a schematic side sectional view of a receiver assembly of the type shown in FIG. 1 in which the radiation guide has an elongate region containing substantially no wavelength converting elements;

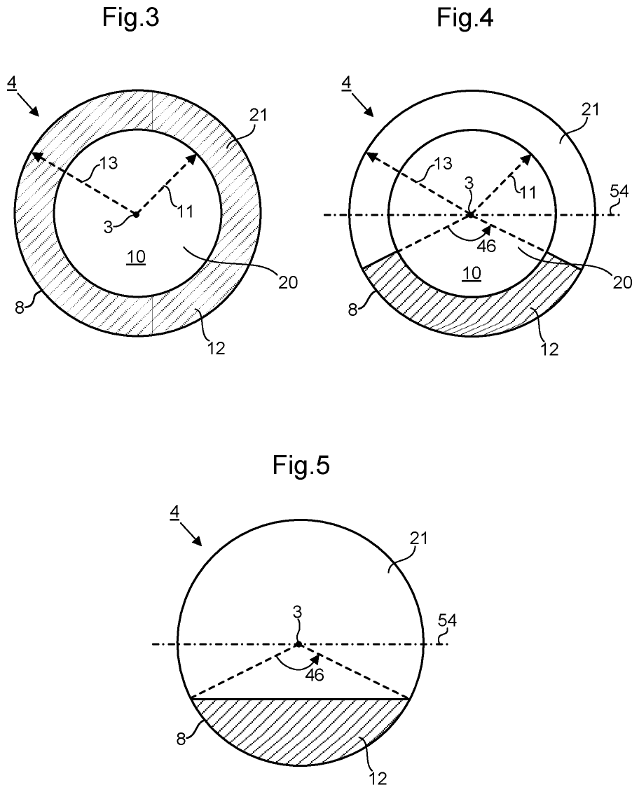

FIG. 3 is a schematic end sectional view of a radiation guide of the type shown in FIG. 2 in which wavelength converting elements are provided only in a radially outer region;

FIG. 4 is a schematic end sectional view of an alternative version of a radiation guide of the type shown in FIG. 2 in which wavelength converting elements are provided only in a radially outer region and within a range of azimuthal angles of less than 180 degrees;

FIG. 5 is a schematic end sectional view of a further radiation guide of the type depicted in FIG. 2 in which wavelength converting elements are provided only in a radially outer region and within a range of azimuthal angles of less than 180 degrees;

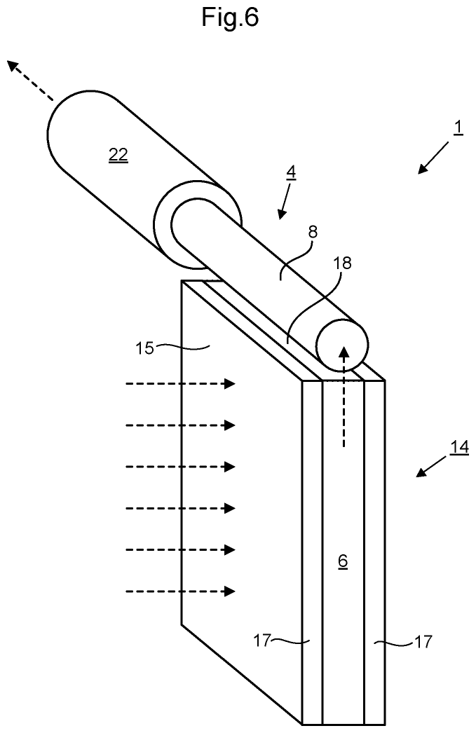

FIG. 6 is a schematic perspective view of a receiver assembly comprising an elongate radiation guide and a planar concentration stage outputting radiation onto an outer lateral surface of the radiation guide;

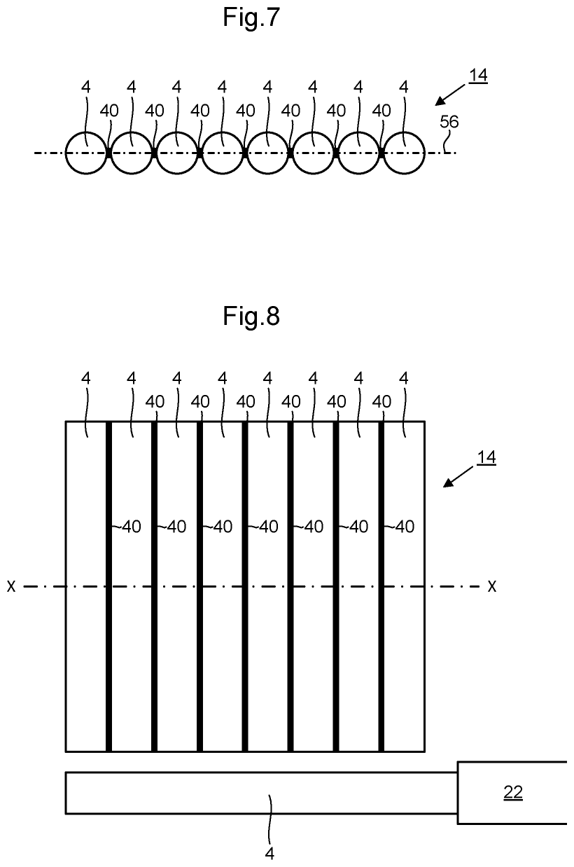

FIG. 7 is a schematic end sectional view relative to dot-chain line X-X in FIG. 8 of a receiver assembly comprising a plurality of radiation guides;

FIG. 8 is a schematic top view of the receiver assembly of FIG. 7;

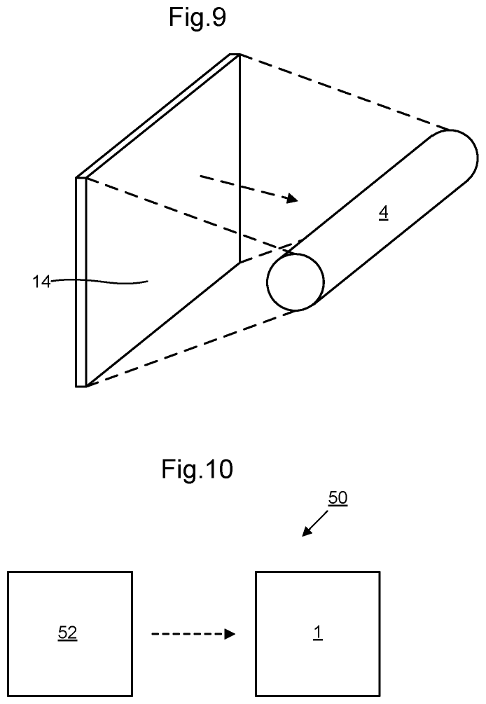

FIG. 9 is a schematic perspective view of a receiver assembly comprising an elongate radiation guide and a lens outputting radiation onto the outer lateral surface of the radiation guide;

FIG. 10 depicts a communication system comprising a transmitter assembly and a receiver assembly; and

FIG. 11 is a schematic side sectional view of a concentrator illustrating the principle of operation of a concentrator comprising wavelength converting elements.

As mentioned in the introductory part of the description, optical concentration can be used to reduce the size of photo-detectors required in free space optical communications applications. However, the amount of concentration that can be achieved using conventional methods such as lenses or compound parabolic concentrators is limited by the conservation of étendue. Concentration levels greater than the limits imposed by the conservation of étendue for a single wavelength of light can be achieved by changing the wavelength of the light during the concentration process. In embodiments of the invention this is achieved using one or more “wavelength converting elements”. A wavelength converting element absorbs radiation at one wavelength or range of wavelengths and re-emits the radiation at a second wavelength or range of wavelengths that is different to the first. The conversion may involve shifting from a shorter wavelength to a longer wavelength. In an embodiment, the wavelength converting element is configured to have a short response time, for example of 1 microsecond or less, optionally 10 nanoseconds or less, optionally 1 nanosecond or less, in order to facilitate high bandwidth data communications. Examples of wavelength converting elements are described in further detail below.

In an embodiment, variations of which are described in further detail below with reference to FIGS. 1-9, there is provided a receiver assembly 1. The assembly 1 comprises a radiation guide 4. The radiation guide 4 has an elongate form with a longitudinal axis 3. A dimension of the radiation guide 4 along the longitudinal axis 3 (which may be referred to as the length of the radiation guide 4) is at least five times longer than all dimensions of the radiation guide 4 perpendicular to the longitudinal axis 3, optionally at least 10 times longer, optionally at least 25 times longer, optionally at least 50 times longer.

In the example of FIG. 1, the radiation guide 4 has a circular cross-section. The longest dimension perpendicular to the longitudinal axis 3 is therefore the diameter of the circular cross-section. The radiation guide 4 is therefore at least five times longer than the diameter of the cross-section of the radiation guide 4 in the case where the cross-section of the radiation guide 4 is circular.

The radiation guide 4 receives radiation via an outer lateral surface 8 of the radiation guide 4.

The radiation guide 4 converts the received radiation to longer wavelength radiation within the radiation guide 4. The conversion may be implemented using one or more wavelength converting elements configured to convert radiation to longer wavelength radiation. The spectrum of radiation is thus changed by shifting power from a first wavelength or wavelengths to a second wavelength or wavelengths. In an embodiment, the one or more wavelength converting elements is/are provided within the radiation guide 4, for example distributed in a medium forming part of the radiation guide 4. The one or more wavelength converting elements may comprise fluorophores, which operate on the basis of fluorescence. The wavelength converting elements may comprise fluorescent dye. Alternatively or additionally, the wavelength converting elements may comprise quantum dot wavelength converters, for example solution processed quantum dots. Solution processed quantum dots are particularly suitable for this application because they have tuneable absorption and emission characteristics, large luminescence quantum yields and Stokes shifts compatible with minimal re-absorption losses. The one or more wavelength converting elements may optionally be substantially transparent to converted radiation so as to reduce or minimize re-absorption losses.

In an embodiment, the conversion of the received radiation to longer wavelength radiation in the radiation guide comprises one or more of the following: conversion of infrared or near-infrared radiation to infrared radiation or near-infrared radiation having a longer wavelength, conversion of UV radiation to visible radiation, conversion of UV radiation to infrared or near-infrared radiation, conversion of visible radiation to visible radiation having a longer wavelength, and conversion of visible radiation to infrared or near-infrared radiation. In one particular embodiment, radiation is absorbed at approximately 475 nm and re-emitted at approximately 600 nm. Such a system may be implemented using the dye Ru(BPY)3 for example. Many other dyes may be used. Alternatively or additionally, quantum dots may be used. For example, Qdot® (Life Technologies Corporation) quantum dots may be used, which are available in various different formats with different absorption and emission characteristics. Qdot® 605, or Qdot® 655, which have respective emission maxima of about 605 nm and about 655 nm may be used for example.

The radiation guide 4 guides the converted radiation, for example by total internal reflection, to a longitudinal end surface 2 of the radiation guide 4. The geometry of the radiation guide 4 is such that radiation is concentrated from the outer lateral surface 8 to the longitudinal end surface 2. A photon flux density at the longitudinal end surface 2 (peak and/or spatially averaged) is therefore higher than a photon flux density at the outer lateral surface 8 (peak and/or spatially averaged).

In an embodiment, a receiver unit 5 receives radiation output from the longitudinal end surface 2 of the radiation guide 4. The receiver unit 5 may comprise a decoder unit capable of obtaining information modulated onto radiation received by the assembly 1. The decoder unit thus allows the information to be extracted from the received radiation. The decoder unit may optionally be configured to ascertain radiation direction from the information. The receiver unit may be configured to both generate power and obtain information from received radiation. Thus the receiver assembly 1 may be used to both power a mobile device and facilitate communication via incoming radiation.

In an embodiment, wavelength converting elements are distributed non-uniformly through a cross-section of the radiation guide 4. For example, a spatial density (number per unit volume), averaged over the length of the radiation guide 4, varies as a function of position in the cross-section.

In an embodiment, examples of which are illustrated in FIGS. 2-5, a spatial density of wavelength converting elements in the radiation guide 4, averaged over the length of the radiation guide 4, varies as a function of radius relative to the longitudinal axis 3. In an embodiment, the spatial density increases monotonically from the longitudinal axis 3 to the outer lateral surface 8 of the radiation guide 4.

In the examples of FIGS. 2-5, the radiation guide 4 comprises a core 20 of an optical fibre (e.g. an optical fibre with the outer cladding removed). The radiation guide 4 further comprises an outer layer 21 on the core 20. In embodiments of this type (manufactured using the core 20 of an existing optical fibre) the conversion of the received radiation to longer wavelength radiation is performed at least partially in the outer layer 21. In the particular examples of FIGS. 2-5, the conversion occurs entirely within the outer layer 21. Wavelength converting elements are therefore provided exclusively in the outer layer 21, thereby providing the variation (a step change at the boundary between the core 20 and the outer layer 21 in this case) in the spatial density of wavelength converting elements with radius.

The outer layer 21 may be provided along the whole length of the radiation guide 4 or along only a portion of the whole length of the radiation guide 4. In the examples of FIGS. 2-5, the outer layer 21 is provided on a distal portion of the core 20 only (where the cladding has been removed). The cladding 22 is left in place on a proximal portion of the core 20 (nearest the receiver 5). The cladding 22 may desirably provide a reflective interface with respect to the converted radiation in the region adjacent to the receiver unit 5, thereby promoting efficient guiding of the converted radiation to the receiver unit 5. As shown in FIG. 2, the region comprising the cladding 22 is short in these examples relative to the region where the wavelength converting outer layer 21 is provided, but in practice it could be made as long as is convenient to convey the radiation from where it is initially collected (via the outer lateral surface 8) to where it is decoded and processed further (in the receiver unit 5).

In the example of FIG. 3 the wavelength converting elements 12 are distributed uniformly through the whole outer layer 21. This approach benefits from relative ease of manufacture. However, as explained in the introductory part of the description, the wavelength converting elements 12 may alternatively be concentrated in regions where it is expected that incident radiation will be focussed by the particular geometry of the radiation guide 4. For example, in the case of a cylindrical radiation guide 4 and plane wave incident radiation, it would be expected that radiation would be focussed towards a rear side of the radiation guide 4 (the side opposite to the incident radiation) and wavelength converting elements 12 would desirably then be localised more towards the rear side than towards the front side. Arrangements of this type would have more than 51%, optionally more than 60%, optionally more than 70%, optionally more than 80%, optionally more than 90%, optionally more than 95%, optionally substantially all of, the wavelength converting elements 12 located within an azimuthal angle 46 of 180 degrees, optionally 160 degrees, optionally 140 degrees, optionally 120 degrees, optionally 90 degrees, relative to the longitudinal axis 3. FIGS. 4 and 5 show two example arrangements (in which the “front side” is the upper side in the orientation of the figure and the “rear side” is the lower side). The arrangement of FIG. 4 could be manufactured for example by replacing a selected angular portion of the outer cladding of an optical fibre with a medium comprising wavelength converting elements. The arrangement of FIG. 5 could be manufactured for example by forming a mould from a waveguide such as an optical fibre, polishing one side of the waveguide until it is flat, replacing the polished waveguide in the mold, filling the empty part of the mold with a material containing wavelength converting elements (e.g. a fluorophore doped mixture that sets), and letting the assembly set.

In the particular examples of FIGS. 4 and 5, substantially all of the wavelength converting elements 12 are located within the outer layer 21 and within an azimuthal angle 46 of about 135 degrees. Alternatively or additionally, where the cross-section of the radiation guide 4 is mirror symmetric (e.g. circular) about a line of symmetry 54 passing through the longitudinal axis 3 (e.g. a diameter), more than 51%, optionally more than 60%, optionally more than 70%, optionally more than 80%, optionally more than 90%, optionally more than 95%, optionally substantially all of, the wavelength converting elements are located to one side of the line of symmetry 54, averaged over the length of the radiation guide 4. This condition is also satisfied in the particular examples shown in FIGS. 4 and 5.

In an embodiment the radiation guide 4 comprises an elongate region which comprises substantially no wavelength converting elements. In the case where the radiation guide 4 is formed from the core 20 of an optical fibre, the elongate region may conveniently be provided by the core 20 itself. This is the case in the examples of FIGS. 2-5. The elongate region extends from the receiver unit 5 at least partially along the full length of the radiation guide 4. The elongate region helps to provide an efficient low absorption path to the receiver unit 5 for radiation that has been converted by the wavelength converting elements, thereby improving efficiency. Using the core 20 of an optical fibre for the elongate region enables this improved efficiency to be obtained at low cost.

In an embodiment, as depicted in FIGS. 3 and 4, the radiation guide 4 comprises a first region 10 encompassing all material within a first radius 11 relative to the longitudinal axis 3 and a second region 12 encompassing all material from the first radius 11 to a second radius 13 relative to the longitudinal axis 3. In the examples of FIGS. 2-4, the first radius 11 corresponds to the outer radius of the core 20. The volume of the core 20 is therefore an example of the first region 10. The second radius 13 in this example corresponds to the outer radius of the outer layer 21. The volume of the outer layer 21 is therefore an example of the second region 12. The first and second regions 10, 12 are characterized by substantially all of the wavelength converting elements within the radiation guide 4 being located in the second region 12. Thus the second region 12 performs substantially all of the conversion to longer wavelength radiation, while the first region 10 efficiently guides the converted radiation to the receiver 5. The first radius 11 may optionally be at least 25%, optionally at least 50%, or optionally at least 75%, of the second radius 13. The second radius 13 may optionally be equal to the radius of a circular cross-section of the radiation guide 4. In an embodiment, a refractive index of the first region 10 is within 10% of the refractive index of the second region 12. The refractive index of the first region 10 may optionally be substantially equal to the refractive index of the second region 12. Reflection at the interface between the first and second regions 10, 12 is therefore low, allowing converted radiation to pass efficiently from the second region 12 to the first region 10.

In an embodiment, the radiation guide 4 has a circular cross section along its whole length. The cross section may alternatively be elliptical, square, rectangular or any other regular or irregular shape which is capable of effectively guiding radiation. The radiation guide 4 may be straight or curved along its longitudinal axis.

In an embodiment, examples of which are shown in FIGS. 6-9, the receiver assembly 1 further comprises a concentration stage 14 that concentrates radiation received via an input surface 15 of the concentration stage 14 onto the outer lateral surface 8 of the radiation guide 4. The input surface 15 of the concentration stage 14 is less elongate than the outer lateral surface 8 of the radiation guide 4 when viewed in a direction perpendicular to the longitudinal axis 3. The concentration stage 14 provides concentration in addition to the concentration provided by the radiation guide 4.

In an embodiment, the input surface 15 is substantially planar, as shown in the example of FIG. 6. The concentration stage 14 as a whole may also be provided in a substantially planar form, for example having a thickness that is at least 10 times, optionally at least 50 times, optionally at least 100 times, smaller than the length and/or width of the concentration stage 15. A large collection area in a relatively small volume device can thus be provided.

In an embodiment, the concentration stage 14 comprises one or more wavelength converting elements. In the example of FIG. 6 the wavelength converting elements are distributed in a medium 6 provided in the concentration stage 14. The wavelength converting elements may be different from the wavelength converting elements provided in the radiation guide 4. Thus, the benefits of improved gain or field of view can be obtained for both the radiation guide 4 and the concentration stage 14.

In embodiments of the type shown in FIG. 6, the concentration stage 14 comprises a confinement structure 17 that substantially allows passage of radiation having a wavelength suitable for conversion by wavelength converting elements in the concentration stage 14 (e.g. in the medium 6 in the example of FIG. 6) from the outside of the confinement structure 17 to the inside of the confinement structure 17. The confinement structure 17 further substantially blocks passage of radiation that has been converted by wavelength converting elements in the concentration stage 14 from the inside of the confinement structure 17 to the outside of the confinement structure 17. Radiation emitted by the wavelength converting elements may thus be directed efficiently towards the radiation guide 4 via internal reflections from the confinement structure 17. The confinement structure 17 thus reduces losses.

In the example of FIG. 6 the confinement structure 17 comprises two substantially planar elements (e.g. dichroic plates) and the wavelength converting elements in the concentration stage 14 (e.g. in medium 6) are located in between the two substantially planar elements. Converted radiation is trapped by the two planar elements and guided towards the radiation guide 4.

Where the concentration stage 14 comprises a confinement structure 17, the confinement structure 17 may concentrate radiation towards one or more output surfaces 18 of the concentration stage 14. In an embodiment, an input surface 15 through which radiation to be converted by wavelength converting elements in the concentration stage 14 can enter the confinement structure 17 is less elongate than an output surface 18 through which radiation can leave the confinement structure 17 and enter the radiation guide 4. Thus the confinement structure 17 allows radiation to be collected over a large area, converted to a different wavelength and concentrated into the relatively more elongate radiation guide 4.

In an embodiment, a dimension of the output surface 18 of the confinement structure 17 that is perpendicular to the longest axis of the output surface 18 (e.g. defined by the separation between the plates forming the confinement structure 17 in the example of FIG. 6) is substantially equal to an average dimension of the radiation guide 4 perpendicular to the longitudinal axis 3 of the radiation guide 4. Thus, in the case where the radiation guide 4 is cylindrical and the output surface 18 is rectangular, the diameter of the radiation guide 4 may be substantially equal in size to the short axis of the output surface 18. Losses of radiation between the output surface 18 and the radiation guide 4 may thus be minimised. A dimension of the output surface 18 of the confinement structure 17 that is perpendicular to the longest axis of the output surface 18 may optionally be smaller than an average dimension of the radiation guide 4 perpendicular to the longitudinal axis 3 of the radiation guide 4 (e.g. the short axis of a rectangular output surface 18 may be smaller than a diameter of a cylindrical radiation guide 4). This arrangement again favours low losses associated with transfer of radiation from the confinement structure 17 to the radiation guide 4.

In an embodiment a small gap may be provided between the radiation guide 4 and the confinement structure 17 to prevent leakage of radiation from the radiation guide 4 back into the confinement structure 17. Alternatively or additionally a lens or parabolic concentrator could be provided between the radiation guide 4 and the confinement structure 14. This would make it possible for the radiation guide 4 to be made slightly smaller.

The radiation guide 4 of FIG. 6 will have to receive radiation that has been retained by total internal reflection within the concentration stage 14 and which therefore has a wide range of incident angles when it leaves the concentration stage 14. The radiation will therefore be more diffuse within the radiation guide 4 than radiation 4 which has arrived directly from a distant source. This means that the wavelength converting elements may desirably be distributed more uniformly in the radiation guide 4 than in a radiation guide 4 (such as that of FIG. 4 or 5) which is configured to receive radiation directly from a distant source, for example with no variation with azimuthal angle and/or no radial variation.

FIGS. 7 and 8 depict an example of an embodiment in which a concentration stage 14 is formed from a plurality of the radiation guides 4. FIG. 7 depicts a cross-sectional view along dot-chain line X-X through the plurality of radiation guides 4. The radiation guides 4 are connected together, and optionally optically isolated from each other, by connectors 40. The radiation guides 4 are positioned adjacent to each other and parallel to each other in a raft-like arrangement, thereby collectively providing a relative large input surface (formed from all of the upper surfaces of the radiation guides in the orientation of FIG. 7). The radiation guides 4 of the concentration stage 14 are particularly likely to be configured to receive radiation arriving from a distant source (therefore approximately plane waves). The wavelength converting elements in the radiation guides 4 may therefore desirably be concentrated towards a rear surface of the radiation guide in each case (as discussed above with reference to FIGS. 4 and 5). In an embodiment of this type, the radiation guides 4 of the concentration stage 14 are arranged so that at least a portion of each of their longitudinal axes lies in a common plane 56 and more than 51%, optionally more than 60%, optionally more than 70%, optionally more than 80%, optionally more than 90%, optionally more than 95%, optionally substantially all of, the wavelength converting elements in each radiation guide 4, in at least the portion having the longitudinal axis lying in the common plane 56, are located to one side of the common plane 56 the rear relative to incoming radiation).

Radiation output from the longitudinal end surfaces of the radiation guides 4 corresponds to the radiation output from the output surface 18 in FIG. 6 and enters the radiation guide 4 located in the lower part of FIG. 8, which concentrates the radiation further and conveys the radiation to a receiver unit 5 (not shown). This radiation guide 4 will have to receive radiation that has been retained by total internal reflection and which therefore has a wide range of incident angles. The radiation will therefore be more diffuse (less focussed) within the radiation guide, meaning that the wavelength converting elements may desirably be distributed more uniformly than in the radiation guides 4 of the concentration stage 14, for example with no variation with azimuthal angle and/or no radial variation.

Relative to the arrangement of FIG. 6, the concentration stage 14 of FIGS. 7 and 8 may be able to achieve lower edge losses because radiation is conveyed more directly towards the radiation guide 4.

In an embodiment, an example of which is shown in FIG. 9, the concentration stage 14 comprises a lens having an elongate focus. The lens may be a Fresnel lens, for example a cylindrical Fresnel lens.

In an embodiment, as depicted schematically in FIG. 10, a communication system 50 is provided which comprises a transmitter assembly 52 and a receiver assembly 1 according to any embodiment. For example, a transmitter assembly 52 in one or more primary devices may be configured to modulate radiation, for example using amplitude modulation, either pulses or carrier frequencies. The radiation may then be directed in a general direction and pass into the receiver assembly 1 of one or more secondary devices separate from the one or more primary devices. The radiation may then be wavelength converted and concentrated onto a receiver unit 5 capable of extracting information from the radiation. Thus data can be transferred from one or more primary devices to one or more secondary devices. Each of the transmitter assemblies 52 may be associated for example with an individual mobile device (such as a mobile telephone, tablet, etc.) desiring to communicate with the one or more secondary devices independently of any other mobile devices in the vicinity.

1. A receiver assembly, comprising:
a radiation guide having an elongate form with a length that is at least five times longer than all dimensions of the radiation guide perpendicular to the longitudinal axis, the radiation guide being configured to receive radiation via an outer lateral surface of the radiation guide, convert the received radiation to longer wavelength radiation within the radiation guide, and guide the converted radiation to a longitudinal end surface of the radiation guide; and
a receiver unit configured to receive radiation output from the longitudinal end surface of the radiation guide.

2. The assembly of claim 1, wherein the radiation guide is configured to concentrate radiation from the outer lateral surface to the longitudinal end surface, such that a photon flux density at the longitudinal end surface is higher than a photon flux density at the outer lateral surface.

3. The assembly of claim 1, wherein the radiation guide has a circular cross-section perpendicular to the longitudinal axis.

4. The assembly of claim 1, wherein wavelength converting elements are distributed non-uniformly through a cross-section of the radiation guide, averaged over the length of the radiation guide.

5. The assembly of claim 4, wherein the cross-section of the radiation guide is mirror symmetric about a line of symmetry passing through the longitudinal axis and more than 51% of the wavelength converting elements are located to one side of the line of symmetry, averaged over the length of the radiation guide.

6. The assembly of claim 4, wherein more than 51% of the wavelength converting elements are located within a range of azimuthal angles of less than 180 degrees relative to the longitudinal axis, averaged over the length of the radiation guide.

7. The assembly of claim 1, wherein a spatial density of wavelength converting elements in the radiation guide, averaged over the length of the radiation guide, varies as a function of radius relative to the longitudinal axis.

8. The assembly of claim 7, wherein the spatial density increases monotonically from the longitudinal axis to the outer lateral surface of the radiation guide.

9. The assembly of claim 7, wherein an elongate region within the radiation guide comprises substantially no wavelength converting elements.

10. The assembly of claim 7, wherein the radiation guide comprises a first region encompassing all material within a first radius relative to the longitudinal axis and a second region encompassing all material from the first radius to a second radius relative to the longitudinal axis, wherein substantially all of the wavelength converting elements within the radiation guide are located in the second region.

11. The assembly of claim 10, wherein the first radius is at least 25% of the second radius.

12. The assembly of claim 10, wherein the radiation guide has a circular cross-section along its whole length and the second radius is equal to the radius of the circular cross-section.

13. The assembly of claim 10, wherein a refractive index of the first region is within 10% of the refractive index of the second region.

14. The assembly of claim 1, further comprising a concentration stage configured to concentrate radiation received via an input surface of the concentration stage onto the outer lateral surface of the radiation guide, wherein the input surface of the concentration stage is less elongate than the outer lateral surface of the radiation guide when viewed in a direction perpendicular to the longitudinal axis.

15. The assembly of claim 14, wherein the concentration stage comprises a lens having an elongate focus.

16. The assembly of claim 14, wherein the lens is a Fresnel lens.

17. The assembly of claim 16, wherein the concentration stage comprises one or more wavelength converting elements configured to convert radiation to longer wavelength radiation.

18. The assembly of claim 17, wherein the concentration stage comprises a confinement structure that is configured substantially to allow passage of radiation having a wavelength suitable for conversion by the wavelength converting elements in the concentration stage from the outside of the confinement structure to the inside of the confinement structure, and substantially to block passage of radiation that has been converted by wavelength converting elements in the concentration stage from the inside of the confinement structure to the outside of the confinement structure.

19. The assembly of claim 18, wherein an input surface through which radiation to be converted by wavelength converting elements in the concentration stage can enter the confinement structure is less elongate than an output surface through which radiation can leave the confinement structure and enter the radiation guide.

20. The assembly of claim 19, wherein a dimension of the output surface of the confinement structure that is perpendicular to the longest axis of the output surface is substantially equal to an average dimension of the radiation guide perpendicular to the longitudinal axis of the radiation guide.

21. The assembly of claim 18, wherein the confinement structure comprises two substantially planar elements and the wavelength converting elements in the concentration stage are located in between the two substantially planar elements.

22. The assembly of claim 14, wherein the concentration stage comprises a plurality of the radiation guides.

23. The assembly of claim 22, wherein the radiation guides of the concentration stage are arranged so that at least a portion of each of their longitudinal axes lies in a common plane and more than 51% of wavelength converting elements in each radiation guide, in at least the portion having the longitudinal axis lying in the common plane, are located to one side of the common plane.

24. The assembly of claim 1 in which the conversion of the received radiation to longer wavelength radiation in the radiation guide comprises one or more of the following: conversion of infrared or near-infrared radiation to infrared radiation or near-infrared radiation having a longer wavelength, conversion of UV radiation to visible radiation, conversion of UV radiation to infrared or near-infrared radiation, conversion of visible radiation to visible radiation having a longer wavelength, and conversion of visible radiation to infrared or near-infrared radiation.

25. The assembly claim 1, wherein the radiation guide comprises a core of an optical fibre.

26. The assembly of claim 25, wherein the radiation guide further comprises an outer layer on the core of the optical fibre, and wherein the conversion of the received radiation to longer wavelength radiation is performed at least partially in the outer layer.

27. The assembly of claim 1, wherein the receiver unit comprises a decoder unit configured to obtain information modulated onto radiation received by the receiver assembly.

28. (canceled)

29. A data communications method, comprising:
transmitting radiation modulated with information from a transmitter assembly; and
receiving and decoding the transmitted radiation using the receiver assembly of claim 1.

30. A method of receiving radiation for data communications, comprising:
receiving radiation on an outer lateral surface of a radiation guide having an elongate form with a length that is at least five times longer than all linear dimensions of the radiation guide perpendicular to the longitudinal axis;
converting the received radiation to longer wavelength radiation within the radiation guide and guiding the converted radiation to a longitudinal end surface of the radiation guide; and
receiving radiation output from the longitudinal end surface of the radiation guide.

31. (canceled)

32. (canceled)
